(19) United States
(12) Patent Application Publication
(10) Pub. No.: US 2026/0080471 A1
(43) Pub. Date: Mar. 19, 2026

(54) SYSTEM AND METHOD FOR BACKTESTING ECONOMIC CALENDAR

(71) Applicant: FX Replay, Inc, Oklahoma City, OK (US)

(72) Inventors: Rodrigo A. Collao Benitez, Norman, OK (US); Matthew Concordia, Innisfil (CA); John H. Goocher, Davidson, NC (US)

(21) Appl. No.: 19/329,334

(22) Filed: Sep. 15, 2025

Related U.S. Application Data
(60) Provisional application No. 63/695,187, filed on Sep. 16, 2024.

(51) Int. Cl. G06Q 40/04

(52) U.S. Cl. CPC G06Q 40/042

(57) ABSTRACT

Disclosed herein is a system comprising a processor and a memory. The memory stores instructions causing the processor to: generate a backtesting view on an output for a backtesting session comprising a historic market instrument, the backtesting view having a first simulation time; retrieve economic events data comprising at least one economic event having event properties, the event properties including an event timestamp and an event value, the event timestamp being subsequent to the first simulation time; display an economic calendar comprising an economic event item in an economic calendar drawer of the backtesting view, the economic event item having an actual value label having a value placeholder; advance the first simulation time to a second simulation time at or after the event timestamp; and cause the output to show the event value for the actual value label and not show the value placeholder for the actual value label.

### CROSS-REFERENCE TO RELATED APPLICATIONS

This application claims priority to the provisional patent application identified by U.S. Ser. No. 63/695,187, filed Sep. 16, 2024, the entire content of which is hereby expressly incorporated herein by reference.

### BACKGROUND

In the context of financial market analysis and strategy development, backtesting plays a crucial role in assessing the effectiveness and robustness of trading strategies. By simulating the application of a particular trading strategy on historical securities data, analysts and investors can gain valuable insights into how the particular trading strategy would have performed under various market conditions. However, traditional backtesting methodologies often overlook the significance of economic events and their impact on market dynamics.

Economic events, such as central bank announcements, GDP releases, and employment reports, can significantly influence market sentiment, volatility, and price movements. These events often lead to sudden shifts in market trends and can potentially invalidate the assumptions underlying a trading strategy. Consequently, failing to account for the occurrence and impact of economic events during the backtesting process can result in an incomplete or misleading assessment of a trading strategy's performance.

Moreover, the timing and magnitude of economic events can vary across different time periods and market cycles. A strategy that performs well during a period of low volatility and stable economic conditions may not necessarily maintain its effectiveness during times of heightened uncertainty or market turmoil. Therefore, it is essential for backtesting methodologies to incorporate the ability to simulate the impact of economic events on a strategy's performance across different market scenarios.

However, current backtesting tools often lack the functionality to seamlessly integrate economic event data into the backtesting process without providing users with economic event data for events that have not yet occurred relative to the backtesting time frame. Analysts and investors must manually search for and review the occurrence of significant events, which can be time-consuming and prone to errors. Furthermore, as part of the backtesting process, the user may not be aware of the real-world time period from which a particular backtesting session draws its historical securities data. Traditional methods of providing economic event data displays the entire economic event data for an economic event prior to the event “taking place” within the backtesting time frame, thereby providing users with economic event data that the user would not have known were the user participating in the real-world financial market. In this way, traditional backtesting methods are unable to accurately simulate the application of a particular trading strategy on historical securities data.

Therefore, a need exists for an improved backtesting system that addresses these limitations.

### SUMMARY

To address these limitations, including accurate simulation of a trading strategy on historic market instruments, there is a growing need for a backtesting solution that seamlessly incorporates economic event data into the backtesting process. It is to such a solution that the current disclosure is directed.

The system and method described herein provide a technical solution to the problem of accurately simulating historical market data in a backtesting environment. Specifically, the system dynamically controls the display of economic event data in the primary user interface based on the simulated time, preventing premature disclosure of information that would not have been available to a real-world trader. This improves the accuracy and realism of the backtesting simulation.

Furthermore, the system employs a novel approach to efficiently manage and display large amounts of economic event data. Rather than repeatedly querying the backtesting system for updated economic event data as the simulation time advances, the system retrieves a comprehensive set of economic event data upfront. The system then uses client-side processing to selectively reveal or hide portions of the economic event data based on the current simulation time. In this way, network traffic requirements and backtesting system server load can be reduced, while enabling responsive updates to the user interface. The result is a more efficient and performant backtesting system that can handle complex simulations with numerous economic events.

The problem of seamlessly incorporating economic event data into the backtesting process, while not providing the user with information that would not have been available to a trader in real-world financial markets, is solved by the systems and methods herein disclosed. The systems and methods include a system comprising an output device, an input device operable to receive one or more input from a user having a user account, a processor and a memory. The memory comprises a non-transitory processor-readable medium storing processor-executable instructions that when executed by the processor, causes the processor to: generate a backtesting session view on the output device for a backtesting session comprising a historic market instrument mapped on a graph, the graph having an axis of abscissas corresponding to a time and an axis of ordinates corresponding to a value of the historic market instrument, the backtesting session view having a first simulation time; retrieve economic events data comprising at least one economic event having a plurality of event properties, the plurality of event properties including at least an event timestamp and an event actual value, the event timestamp being subsequent to the first simulation time; display an economic calendar comprising an economic event item associated with the at least one economic event in an economic calendar drawer of the backtesting session view, the economic event item having an actual value label having a value placeholder; advance the first simulation time to a second simulation time at or after the event timestamp; and cause the output device to show the event actual value for the actual value label of the economic event item and not show the value placeholder for the actual value label.

The systems and methods also include a method for backtesting financial strategies comprising A method for backtesting financial strategies, comprising: generating, by a processor, a backtesting session view on an output device for a backtesting session comprising a historic market instrument mapped on a graph, the graph having an axis of abscissas corresponding to a time and an axis of ordinates corresponding to a value of the historic market instrument, the backtesting session view having a first simulation time; retrieving, by the processor, economic events data comprising a plurality of economic events, each economic event having a plurality of event properties including at least an event timestamp and an event actual value; displaying, by the processor, an economic calendar comprising a plurality of economic event items associated with the plurality of economic events in an economic calendar drawer of the backtesting session view, wherein economic event items having an event timestamp subsequent to the first simulation time display a value placeholder instead of the event actual value; advancing the first simulation time to a second simulation time; updating, by the processor, the display of the economic calendar such that economic event items having an event timestamp between the first simulation time and the second simulation time display the event actual value instead of the value placeholder; and updating, by the processor, the graph to display values of the historic market instrument up to the second simulation time.

The foregoing Summary provides an overview of certain selected implementations or embodiments disclosed herein, and is not intended to describe every aspect, embodiment, implementation, feature, or advantage of the disclosure exhaustively or comprehensively. Therefore, this Summary should not be construed in such a way to limit the scope of this disclosure or to limit the scope of the claims. The details of one or more implementation or embodiment disclosed herein are set forth in the accompanying drawings and descriptions below. Other aspects, features, implementations, embodiments, and advantages will become readily apparent in view of the description, the drawings, and the claims set forth herein.

Implementations of the above techniques include methods, apparatus, systems, and computer program products are described. One such computer program product is suitably embodied in a non-transitory computer-readable medium that stores instructions executable by one or more processors. The instructions are configured to cause the one or more processors to perform the above-described actions.

The details of one or more implementations of the subject matter of this specification are set forth in the accompanying drawings and the description below. Other aspects, features and advantages will become apparent from the description, the drawings, and the claims.

### BRIEF DESCRIPTION OF DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagram of an exemplary embodiment of hardware forming a system constructed in accordance with the present disclosure.

FIG. 2 is a diagram of an exemplary embodiment of a user device for use in the system of FIG. 1 constructed in accordance with the present disclosure.

FIG. 3 is a diagram of an exemplary embodiment of a backtesting system of the system of FIG. 1 constructed in accordance with the present disclosure.

FIG. 4 is a screenshot of an exemplary embodiment of the user device displaying a primary user interface with a backtesting dashboard constructed in accordance with the present disclosure.

FIG. 5 is a screenshot of an exemplary embodiment of the primary user interface displaying a backtesting session view at a first simulation time and constructed in accordance with the present disclosure.

FIG. 6A is a diagram of an exemplary embodiment of an economic calendar of the backtesting session view of FIG. 5 having economic event items.

FIG. 6B is a diagram of an exemplary embodiment of an economic event item of FIG. 6A having the first simulation time.

FIG. 6C is a diagram of an exemplary embodiment of another economic event item of FIG. 6A.

FIG. 6D is a diagram of an exemplary embodiment of an event popup of the backtesting session view of FIG. 5 having the first simulation time.

FIG. 7 is a screenshot of an exemplary embodiment of the primary user interface displaying the backtesting session view of FIG. 5 at a second simulation time and constructed in accordance with the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted. The disclosure is capable of other embodiments or of being practiced or carried out in various ways. Also, it is to be understood that the phraseology and terminology employed herein is for purposes of description and should not be regarded as limiting.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to computing tolerances, computing error, manufacturing tolerances, measurement error, wear and tear, stresses exerted on various parts, and combinations thereof, for example.

As used herein, any reference to “one embodiment,” “an embodiment,” “some embodiments,” “one example,” “for example,” or “an example” means that a particular element, feature, structure, or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

The use of ordinal number terminology (i.e., “first”, “second”, “third”, “fourth”, etc.) is solely for the purpose of differentiating between two or more items and, unless explicitly stated otherwise, is not meant to imply any sequence or order of importance to one item over another.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the disclosure as described herein. Where a range of numerical values is stated herein as being less than a stated value, the range is nevertheless bounded on its lower end by a non-zero value. It is not intended that the scope of the disclosure be limited to the specific values recited when defining a range. All ranges are inclusive and combinable.

Circuitry, as used herein, may be analog and/or digital components, or one or more suitably programmed processors (e.g., microprocessors) and associated hardware and software, or hardwired logic. Also, “components” refers to any functional element that may perform one or more functions. The term “processor,” may include any hardware capable of executing instructions, such as a processor, a microprocessor, an application specific integrated circuit (ASIC), a field programmable gate array (FPGA), a combination of hardware and software, software, and/or the like. The term “processor” as used herein means a single processor or multiple processors working independently or together to collectively perform a task or function.

Software may include one or more computer readable instruction that when executed by one or more component, e.g., a processor, causes the component to perform a specified function. It should be understood that the algorithms described herein may be stored on one or more non-transitory computer-readable medium. Exemplary non-transitory computer-readable media may include a non-volatile memory, a volatile memory, a random-access memory (RAM), a read only memory (ROM), a CD-ROM, a hard drive, a solid-state drive, a flash drive, a memory card, a DVD-ROM, a Blu-ray Disk, a laser disk, a magnetic disk, an optical drive, phase change memory, combinations thereof, and/or the like. Such non-transitory computer-readable media may be electrically based, optically based, magnetically based, material-phase based, resistive based, and/or the like. Further, the messages described herein may be generated by the components and result in various physical transformations.

As used herein, the terms “network-based,” “cloud-based,” and any variations thereof, are intended to include the provision of configurable computational resources on demand via interfacing with a computer and/or computer network, with software and/or data at least partially located on a computer and/or computer network.

As used herein, the term “backtesting” is a method used by investors, traders, and/or financial analysts to evaluate potential performance of a trading strategy or investment model using historical securities trading data/historic market instruments. During backtesting, the trading strategy is applied to a past set of data (such as stock/security trading data) to ascertain how the trading strategy would have performed over a specified period of time. Backtesting involves simulating a historic market instrument as though it was presently being traded, such as in the stock market. The user is provided with an ability to make trades (positions and orders such as limit and stop orders) against the historic data in a simulation time (optionally, corresponding to a historic time for a market that has already closed) and then analyze backtesting results to identify potential trends, risks, and returns. Thus, backtesting helps in refining trading strategies and in identifying potential strengths and weaknesses of those trading strategies before implementing the trading strategies in real-time trading.

Referring now to the drawings, and in particular to FIG. 1, shown therein is a diagram of an exemplary embodiment of a system 10 constructed in accordance with the present disclosure. A user 14 may interact, i.e., via two way-communications, with the system 10 using a user device 18 that may be used to interact with a backtesting system 22. The user device 18 may communicate with the backtesting system 22 via a network 26. In one embodiment, the user 14 may have a user profile associated with user settings that allows the user 14 to access the backtesting system 22 via the user device 18.

In some embodiments, the network 26 may be the Internet and/or other network. For example, if the network 26 is the Internet, a primary user interface 30 (described below in more detail) of the system 10 may be delivered through a series of web pages or private internal web pages of a company or corporation, which may be written in hypertext markup language (HTML/PHP/JavaScript), for example, and may be accessible by the user device 18. It should be noted that the primary user interface 30 of the system 10 may be another type of interface including, but not limited to, a Windows-based application, a server-based application, a tablet-based application, a mobile web interface, an application running on a mobile device, a virtual-reality interface, an augmented-reality interface, and/or the like.

The network 26 may be almost any type of network. For example, in some embodiments, the network 26 may be a version of an Internet network (e.g., exist in a UPD or TCP/IP-based network). In one embodiment, the network 26 is the Internet. It should be noted, however, that the network 26 may be almost any type of network and may be implemented as the World Wide Web (or Internet), a local area network (LAN), a wide area network (WAN), an LPWAN, a LoRa network, a metropolitan network, a wireless network, a WiFi network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, a short-wave wireless network, a long-wave wireless network, combinations thereof, and/or the like. It is conceivable that in the near future, embodiments of the present disclosure may use more advanced networking topologies.

The number of devices and/or networks illustrated in FIG. 1 is provided for explanatory purposes. In practice, there may be additional devices and/or networks, fewer devices and/or networks, different devices and/or networks, or differently arranged devices and/or networks than are shown in FIG. 1. Furthermore, two or more of the devices illustrated in FIG. 1 may be implemented within a single device, or a single device illustrated in FIG. 1 may be implemented as multiple, distributed devices. Additionally, or alternatively, one or more of the devices of system 10 may perform one or more functions described as being performed by another one or more of the devices of the system 10. Devices of the system 10 may interconnect via wired connections, wireless connections, or a combination thereof.

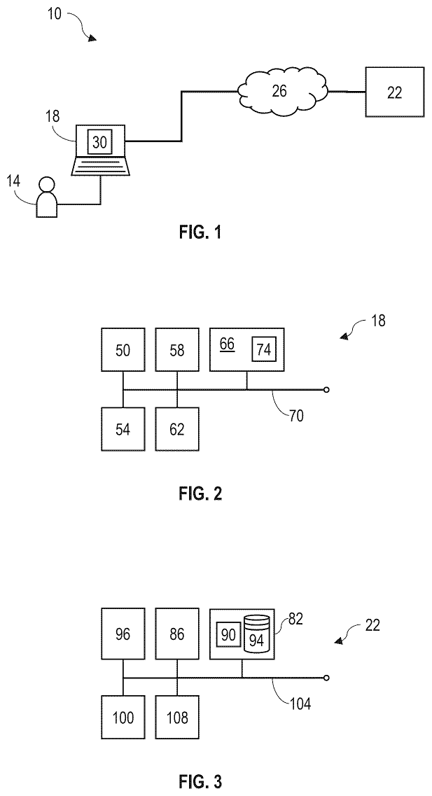

Referring now to FIG. 2, shown therein is a diagram of an exemplary embodiment of the user device 18 of the system 10 constructed in accordance with the present disclosure. In some embodiments, the user device 18 may include, but is not limited to, implementations as a personal computer, a cellular telephone, a smart phone, a network-capable television set, a tablet, a laptop computer, a desktop computer, a network-capable handheld device, a server, a digital video recorder, a wearable network-capable device, a virtual reality/augmented reality device, and/or the like.

In some embodiments, the user device 18 may include one or more input device 50 (hereinafter “input device 50”), one or more output device 54 (hereinafter “output device 54”), one or more processor 58 (hereinafter “processor 58”), one or more communication device 62 (hereinafter “communication device 62”) capable of interfacing with the network 26, one or more memory 66 (hereinafter “memory 66”) storing processor-executable code and/or user application(s) 74 (hereinafter “user application 74”). The user application 74 may include, for example, a web browser capable of accessing a website and/or communicating information and/or data over a wireless or wired network (e.g., the network 26), and/or the like. The input device 50, output device 54, processor 58, communication device 62, and memory 66 may be connected via a path 70 such as a data bus that permits communication among the components of user device 18.

The processor 58 may be implemented as a single processor or multiple processors working together, or independently, to execute the user application 74 as described herein. It is to be understood, that in certain embodiments using more than one processor 58, the processors 58 may be located remotely from one another, located in the same location, or comprising a unitary multi-core processor. The processors 58 may be capable of reading and/or executing processor-executable code and/or capable of creating, manipulating, retrieving, altering, and/or storing data structures into the memory 66.

Exemplary embodiments of the processor 58 may include, but are not limited to, a digital signal processor (DSP), a central processing unit (CPU), a field programmable gate array (FPGA), a graphics processing unit (GPU), a neural processing unit (NPU), a microprocessor, a multi-core processor, an application specific integrated circuit (ASIC), combinations thereof, and/or the like, for example. The processor 58 may be capable of communicating with the memory 66 via the path 70 (e.g., data bus). The processor 58 may be capable of communicating with the input device 50 and/or the output device 54. The processor 58 may include one or more processor 58 working together, or independently, and located locally, or remotely, e.g., accessible via the network 26.

The memory 66 may be one or more non-transitory processor-readable medium. The memory 66 may store the user application 74 that, when executed by the processor 58, causes the user device 18 to perform an action such as communicate with or control one or more component of the user device 18 and/or, via the network 26, the backtesting system 22. The memory 66 may be one or more memory 66 working together, or independently, to store processor-executable code and may be located locally or remotely, e.g., accessible via the network 26.

The input device 50 may be capable of receiving information input from the user 14 and/or processor 58, and transmitting such information to other components of the user device 18 and/or the network 26. The input device 50 may include, but is not limited to, implementation as a keyboard, a touchscreen, a mouse, a trackball, a microphone, a camera, a fingerprint reader, an infrared port, an optical port, a cell phone, a smart phone, a PDA, a remote control, a fax machine, a wearable communication device, a network interface, combinations thereof, and/or the like, for example. The input device 50 may include the primary user interface 30 on the user device 18.

The output device 54 may be capable of outputting information in a form perceivable by the user 14 and/or processor 58. Implementations of the output device 54 may include, but are not limited to, a computer monitor, a screen, a touchscreen, a speaker, a website, a television set, a smart phone, a PDA, a cell phone, a fax machine, a printer, a laptop computer, a haptic feedback generator, an olfactory generator, combinations thereof, and the like, for example. The output device 54 may display the primary user interface 30 on the user device 18.

It is to be understood that in some exemplary embodiments, the input device 50 and the output device 54 may be implemented as a single device, such as, for example, a touchscreen of a computer, a tablet, or a smartphone. It is to be further understood that as used herein the term user (e.g., the user 14) is not limited to a human being, and may comprise a computer, a server, a website, a processor, a network interface, a user terminal, a virtual computer, combinations thereof, and/or the like, for example.

The communication device 62, in communication with the processor 58, may interface with the network 26. The network 26 may permit bi-directional communication of information and/or data between the user device 18 and/or the backtesting system 22. The network 26 may interface with the backtesting system 22 and/or the user device 18 in a variety of ways. For example, in some embodiments, the network 26 may interface by optical and/or electronic interfaces, and/or may use a plurality of network topographies and/or protocols including, but not limited to, Ethernet, UDP/TCP/IP, circuit switched path, combinations thereof, and/or the like, as described above. For example, the processor 58 may be capable of communicating via the network 26 by exchanging signals (e.g., analog, digital, optical, and/or the like) via one or more port (e.g., physical or virtual ports) using a network protocol to provide updated information to the backtesting system 22 (e.g., to a backtesting application 90 (described below) executed on the backtesting system 22).

Referring now to FIG. 3, shown therein is a diagram of an exemplary embodiment of the backtesting system 22 constructed in accordance with the present disclosure. The backtesting system 22 may include one or more device that execute(s) one or more application or service in a manner described herein. In the illustrated embodiment, the backtesting system 22 is provided with a memory 82 (hereinafter “memory 82”) accessible by one or more backtesting processor 86 (hereinafter “backtesting processor 86”). The memory 82 may include one or more non-transitory processor-readable medium storing processor-executable code and/or software application(s) 90 (hereinafter “backtesting application 90”) and one or more database 94 (hereinafter “database 94”).

In some embodiments, the backtesting system 22 may comprise the one or more backtesting processor 86 working together, or independently to, execute processor-executable code, such as the backtesting application 90, stored on the memory 82. Additionally, the backtesting system 22 may include at least one input device 96 (hereinafter “input device 96”) and at least one output device 100 (hereinafter “output device 100”). Each element of the backtesting system 22 may be partially or completely network-based or cloud-based, and may or may not be located in a single physical location.

The backtesting processor 86 may be implemented as a single processor or multiple processors working together, or independently, to execute the backtesting application 90 as described herein. It is to be understood, that in certain embodiments using more than one backtesting processor 86, the backtesting processors 86 may be located remotely from one another, located in the same location, or comprising a unitary multi-core processor. The backtesting processors 86 may be capable of reading and/or executing processor-executable code and/or capable of creating, manipulating, retrieving, altering, and/or storing data structures into the memory 82 such as in the database 94.

Exemplary embodiments of the backtesting processor 86 may be constructed similar to and in accordance with the processor 58 described above in more detail. The backtesting processor 86 may be capable of communicating with the memory 82 via a path 104 (e.g., data bus). The backtesting processor 86 may be capable of communicating with the input device 96 and/or the output device 100.

The backtesting processor 86 may be further capable of interfacing and/or communicating with the user device 18 via the network 26 using a communication device 108. For example, the backtesting processor 86 may be capable of communicating via the network 26 by exchanging signals (e.g., analog, digital, optical, and/or the like) via one or more port (e.g., physical or virtual ports) using a network protocol to provide updated information to the user application 74 or the primary user interface 30 executed on the user device 18.

In some embodiments, the memory 82 may be located in the same physical location as the backtesting system 22, and/or one or more memory 82 may be located remotely from the backtesting system 22. For example, the memory 82 may be located remotely from the backtesting system 22 and communicate with the backtesting processor 86 via the network 26. Additionally, when more than one memory 82 is used, a first memory 82 may be located in the same physical location as the backtesting processor 86, and additional memory 82 may be located in a location physically remote from the backtesting processor 86. Additionally, the memory 82 may be implemented as a “cloud” non-transitory processor-readable medium (i.e., one or more memory 82 may be partially or completely based on or accessed using the network 26).

The memory 82 may store processor-executable code and/or information comprising the database 94 and the backtesting application 90. In some embodiments, the backtesting application 90 may be stored as a compiled application file, such as an executable file, for example, or in a structure (or unstructured) format, such as, e.g., in a non-compiled file.

In one embodiment, the database 94 can be a relational database, a time-series database, a vector database, a non-relational database, a document database, and/or the like, or combinations thereof. Examples of such databases comprise, DB2®, Microsoft® Access, Microsoft® SQL Server, Oracle®, MySQL, PostgreSQL, MongoDB, Apache Cassandra, Weaviate, and the like. It should be understood that these examples have been provided for the purposes of illustration only and should not be construed as limiting the presently disclosed inventive concepts. The database 94 can be centralized or distributed across multiple systems.

The input device 96 of the backtesting system 22 may transmit data to the backtesting processor 86 and may be constructed in accordance with or similar to the input device 50 of the user device 18 described above in more detail. The input device 96 may be located in the same physical location as the backtesting processor 86, or located remotely and/or partially or completely network-based. The output device 100 of the backtesting system 22 may transmit information from the backtesting processor 86 to the user 14, and may be similar to the output device 54 of the user device 18. The output device 100 may be located with the backtesting processor 86, or located remotely and/or partially or completely network-based.

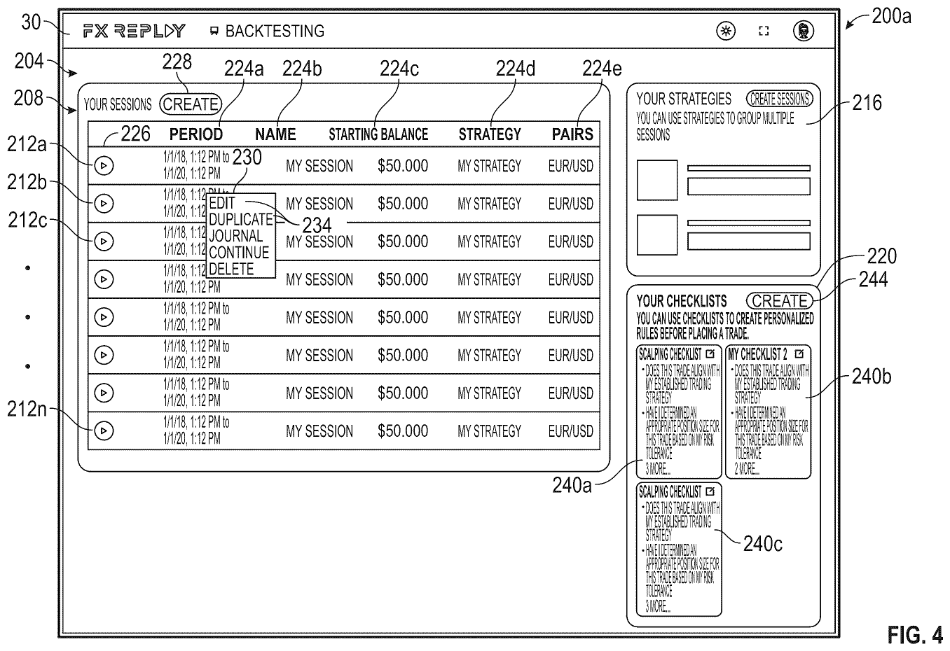

Referring now to FIG. 4, shown therein is a screenshot 200a of an exemplary embodiment of the user device 18 displaying the primary user interface 30 with a backtesting dashboard 204 constructed in accordance with the present disclosure. As shown by the screenshot 200a, the processor 58 may display the primary user interface 30 of the backtesting application 90 on the user device 18 to display a backtesting session list 208 having one or more backtesting item 212a-n associated with a particular backtesting session, a strategy group 216, and a checklist group 220.

In one embodiment, the backtesting dashboard 204 may be generated by the backtesting processor 86 and may be transmitted by the backtesting processor 86 to the processor 58 via the network 26. For example, the backtesting dashboard 204 may be a series of web pages or a web application that is generated by the backtesting processor 86 and displayed on the primary user interface 30 on the output device 54 of the user device 18 by the processor 58, such as by rendering a webpage of the primary user interface 30 using a predetermined computer language, e.g., hypertext markup language (HTML/PHP/JavaScript), for example.

The backtesting session list 208 may display a list of one or more of the backtesting items 212, for which each backtesting item 212 may be associated with a particular backtesting session having session data. The backtesting session list 208 may display the list of all backtesting items 212 for the user, or, in other embodiments, may display a list of a subset of the backtesting items 212 for the user. In one embodiment, the backtesting items 212 associated with particular backtesting sessions having session data may be stored in the memory 82, such as in the database 94. The backtesting processor 86 may transmit selected ones of the backtesting items 212 to the user device 18. The processor 58 of the user device 18 may receive the transmitted backtesting items 212 and may store the backtesting items 212 in the memory 66 and/or may display the list of the one or more of the backtesting items 212 on the output device 54.

As shown in FIG. 4, each backtesting item 212 includes one or more backtesting property label 224 corresponding to a respective backtesting property, for example, shown as a period label 224a, a name label 224b, a starting balance label 224c, a strategy label 224d, and a pairs label 224e. In other embodiments, additional backtesting property labels 224 may be provided. Each backtesting property label 224 may correspond to a backtesting property of the backtesting session. The period label 224a may be a simulation timeframe that a particular backtesting session includes or is executed over, which corresponds to a historic date/time of the historic market instrument. The name label 224b may be a name of the particular backtesting session. The starting balance label 224c may be a starting balance of the particular backtesting session. The strategy label 224d may correspond to a strategy name of a particular strategy in the strategy group 216. The pairs label 224e may refer to any financial instrument or asset available within the particular backtesting session. For example, the pair of instruments may encompass two or more assets, such as one or more financial instruments. The one or more financial instruments may include, for example, stocks, bonds, currency (e.g., United States Dollar (USD), Euro (EUR), and the like), commodities (e.g., gold and silver), and/or any other tradable asset. While each backtesting item 212 is shown with a currency pair associated with the pairs label 224e (e.g., shown with EUR/USD), the pairs are not limited to currency pairs alone and may encompass a wide range of assets or financial instruments that the user desires to analyze.

In one embodiment, each of the one or more backtesting properties are included in the session data and correspond to the backtesting property labels 224 for the associated backtesting session stored in the memory 82, such as in the database 94, and may be associated with the particular backtesting session and the particular user 14. The one or more backtesting properties may further include, for example, a backtesting session identifier, historic market instrument data, an association to the user 14, a simulation timeframe, and/or the like, for example.

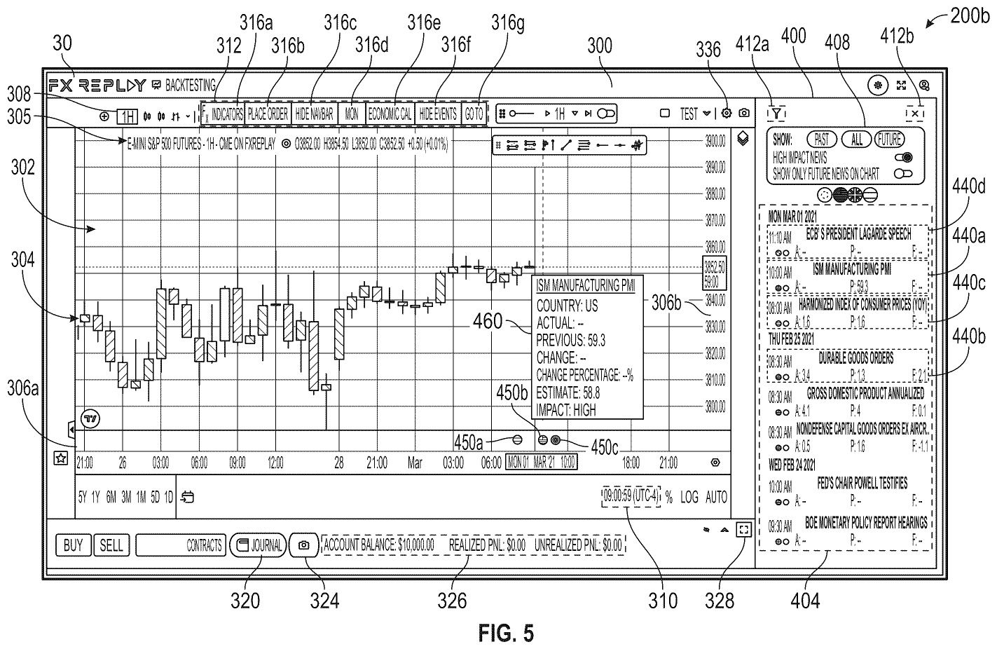

In one embodiment, each backtesting item 212 includes a view input 226. The backtesting processor 86 may receive one or more input from the user device 18 indicative of selection of the view input 226 of a particular backtesting item 212 by the user, and, responsive to the selection, may cause the primary user interface 30 to replay the associated backtesting session of the particular backtesting item 212. For example, the backtesting processor 86, responsive to one or more input, e.g., from the user device 18, may cause the primary user interface 30 to display a backtesting session view 300 (shown in FIG. 5) and be loaded with session data of the associated backtesting session.

In one embodiment, the backtesting processor 86 may receive one or more input from the user device 18 indicative of the user selecting a create input 228. Responsive to the selection of the create input 228, the backtesting processor 86 may generate a new backtesting session.

In one embodiment, the backtesting processor 86 may generate a backtesting item context menu 230 (FIG. 4) responsive to receiving an input from the user via the user device 18. For example, if the user right-clicks (or hold-clicks) a particular backtesting item 212, the backtesting processor 86 may generate the backtesting item context menu 230 having one or more context menu operations 234 operable to, upon selection by the user via the user device 18, cause the backtesting processor 86 to execute a particular function against the backtesting session associated with the particular backtesting item 212. In one embodiment, the one or more context menu operations 234 include operations that when executed by the backtesting processor 86 may cause the backtesting processor 86 to: edit the backtesting session; duplicate the backtesting session; view the journal of the backtesting session; continue the backtesting session; and delete the backtesting session. For example, upon selection of the “Continue” context menu operation 234, the backtesting processor 86, responsive to the selection, e.g., from the user device 18, may cause the primary user interface 30 to display the backtesting session view 300 (shown in FIG. 5) loaded with session data of the backtesting session associated with the particular backtesting item 212.

In one embodiment, the backtesting dashboard 204 may further include the strategy group 216. The strategy group 216 may include one or more session collection having a strategy name and associated with one or more backtesting session. In one embodiment, the one or more backtesting session is mutually exclusive between session collections, that is, each backtesting session can only be associated with one session collection. In other embodiments, each backtesting session can be associated with more than one session collection. As shown, each backtesting item 212 may display the strategy label 224d comprising the strategy name of the session collection of which the backtesting session associated with the backtesting item 212 is a member.

In one embodiment, the backtesting dashboard 204 may further include the checklist group 220. The checklist group 220 may display one or more checklist 240a-n (shown as a first checklist 240a, a second checklist 240b, and a third checklist 240c). Each checklist 240 may be created and customized by the user. In one embodiment, the checklist 240 may be used as a reminder of one or more step that the user has identified as important to follow before the user places an order. Upon selection of a particular checklist 240, the backtesting processor 86 may prompt the user to update or edit the particular checklist 240. In one embodiment, the checklist group 220 may further comprise a new checklist input 244. The backtesting processor 86, responsive to the user selecting the new checklist input 244 may generate a checklist dialog.

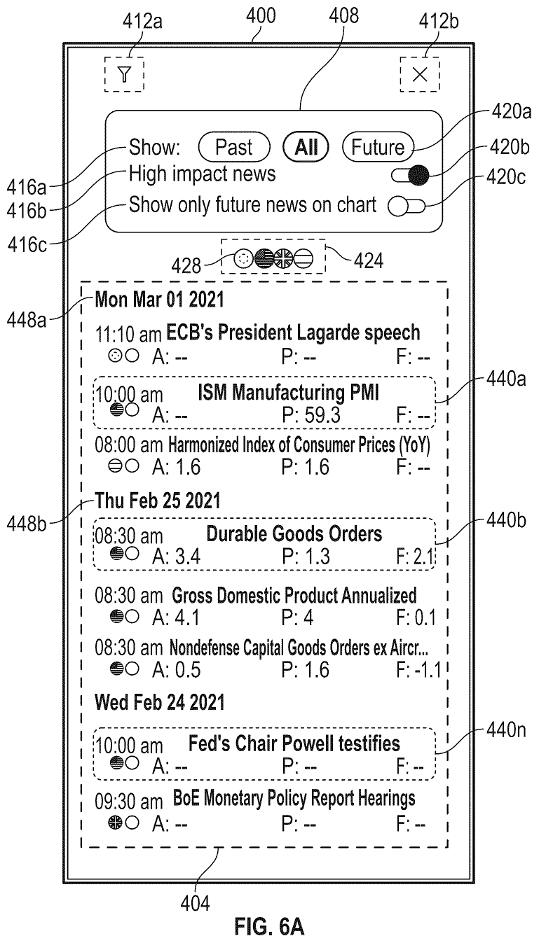

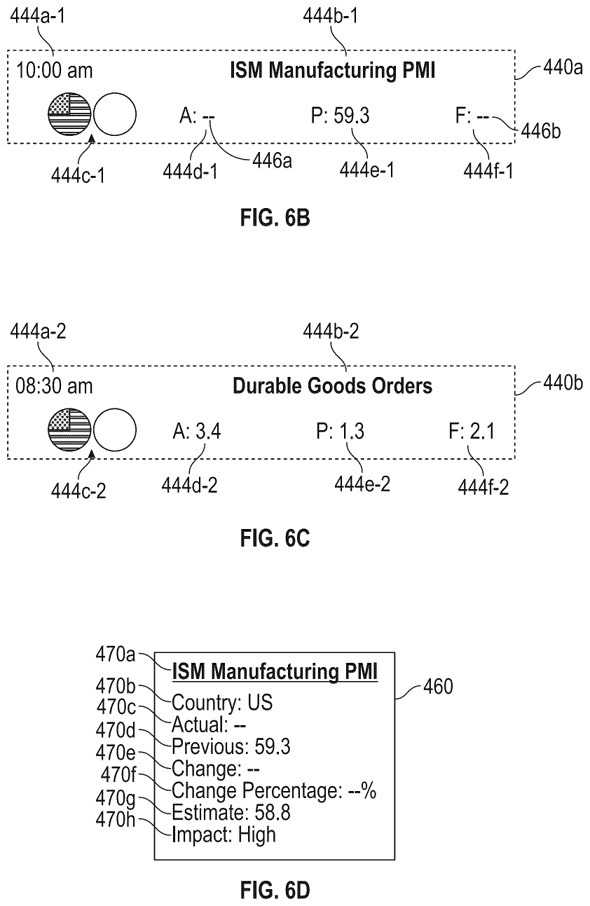

Referring now to FIG. 5 and FIGS. 6A-B, in combination, shown in FIG. 5 is a screenshot 200b of an exemplary embodiment of the user device 18 displaying the primary user interface 30 with a backtesting session view 300 displayed in accordance with the present disclosure. Generally, the backtesting session view 300 displays a backtesting session, such as the backtesting session associated with a particular backtesting item 212 selected by the user 14 from the backtesting dashboard 204.

As shown, the backtesting session view 300 includes a chart 302 having a graph 304, such as a candlestick line graph, showing a value of a historic market instrument 305 (e.g., actual stock data for a stock, financial market, or foreign exchange market that is at least one market-day old, or from a prior market-day) and having an axis of abscissas 306a showing a time, and an axis of ordinates 306b showing a market instrument value. The backtesting session view 300 provides the user with a time granularity 308 corresponding to a timeframe for which each candlestick of the graph 304 of the historic market instrument 305 pertains, as well as an option menu 312 having one or more option 316a-n, shown as options 316a-g, described in detail below.

In one embodiment, the historic market instrument 305 may be, for example, a time-series data having the market instrument value associated with a particular time value. The historic market instrument 305 may be provided with time granularity 308 within the graph 304 where the time granularity 308 is a time delta between consecutive market instrument values in the time-series data. For example, the historic market instrument 305 may have a time granularity 308 of 5 minutes, resulting in the time-series data providing market instrument values in 5-minute increments. In one embodiment, the backtesting processor 86 may calculate the market instrument value for a particular time granularity 308. For example, the historic market instrument 305 may be stored in the memory 82, such as from the database 94, at a first time granularity, such as a first market instrument value for each 0.25-second increment, and the backtesting processor 86 may calculate a second market instrument value at a second time granularity, e.g., for each 5-minute increment, such as, by a high value, low value, beginning value, and ending value of the first market instrument value at each 0.25-second increment within the 5-minute increment as the second market instrument value.

In one embodiment, the backtesting processor 86 may retrieve the value of the historic market instrument 305 from the memory 82, such as from the database 94. In one embodiment, the database 94 storing the historic market instrument values is a non-relational database and/or a time-series database. The value of the historic market instrument 305 may be, for example, stored with, or associated with, the session data.

In one embodiment, the graph 304 may show historic market instrument values for the historic market instrument 305 that have a time value at, or before, a simulation time 310. For example, as shown in FIG. 5, the simulation time 310 is shown as “9:00:59 (UTC-4)” and the primary user interface 30 with the backtesting session view 300 loaded with session data of the associated backtesting session may show the market instrument values for the historic market instrument 305 only up to the market instrument values having a time value at or before the simulation time 310 of 9:00:59 (UTC-4), and may not, for example, display the market instrument values having the time value greater than the simulation time 310. As used herein, reference to “prior market instrument value”, or the like, refers to market instrument values of the historic market instrument 305 prior to the simulation time 310 and within a timeframe of the chart 302. Further, it should be understood that while the graph 304 only shows market instrument values of the historic market instrument 305 having the time value up to and including the simulation time 310, the simulation data of the associated backtesting session may include the time-series data of the historic market instrument 305 for a duration of the associated backtesting session, which includes, for example, market instrument values of the historic market instrument 305 having a time value greater than the simulation time 310.

In one embodiment, the option menu 312 may include an indicator option 316a, a place order option 316b, a hide navbar option 316c, a day option 316d (shown as ‘Mon’ indicating ‘Monday’), an economic calendar option 316e, an events option 316f (shown as ‘Hide Events’), and a Goto option 316g. In one embodiment, the indicator option 316a, when selected by the user, causes the processor 58 to display one or more indicators on the chart 302. In one embodiment, the place order option 316b, when selected by the user, causes the processor 58 to display a place order dialog on the primary user interface 30. In one embodiment, the hide navbar option 316c, when selected by the user, causes the processor 58 to hide the option menu 312 from the display on the chart 302. In one embodiment, the day option 316d, when selected by the user, causes the processor 58 to toggle a “day of week” modal, e.g., when a cursor is within the chart 302 or over the graph 304 of the historic market instrument 305.

In one embodiment, the events option 316f, when selected by the user, causes the processor 58 to toggle display of one or more event icon 450a-n (referred to, generally, as event icon(s) 450; shown, for example, as a first event icon 450a, a second event icon 450b, and a third event icon 450c; and described below) associated with the economic calendar 404 on the chart 302. In some embodiments, a text of the events option 316f may change based on whether the one or more event icons are displayed on the chart 302. For example, if the one or more event icons 450 are displayed on the chart 302, the text of the events option 316f may be “Hide Events” to indicate to the user 14 that selection of the events option 316f when the one or more event icons 450 are displayed on the chart 302 will cause the processor 58 to remove the one or more event icons 450 from the chart 302. If the one or more event icons 450 are not displayed on the chart 302, the text of the events option 316f may be “Show Events” to indicate to the user 14 that selection of the events option 316f when the one or more event icons 450 are not displayed on the chart 302 will cause the processor 58 to draw the one or more event icons 450 onto the chart 302.

In one embodiment, the Goto option 316g, when selected by the user, causes the processor 58 to display a Goto menu on the primary user interface 30 as described in U.S. Provisional Application No. 63/635,712 entitled “System and Method for Selection of Backtesting Time and Region” filed on Apr. 18, 2024, the entire content of which is hereby incorporated herein by reference in its entirety.

In one embodiment, the backtesting session view 300 includes a show journal input 320 operable to cause the processor 58 to display a one or more journal entry or journal screenshot as described in U.S. Provisional Application No. 63/593,113 entitled “Security Trading Backtesting System Having an Interactable Journal” filed on Oct. 25, 2023, the entire content of which is hereby incorporated herein by reference in its entirety.

In one embodiment, the backtesting session view 300 may further include a session balance 326 showing an account balance for the backtesting session, a realized profit and loss for the backtesting session, and an unrealized profit and loss for the backtesting session.

In one embodiment, the backtesting session view 300 may further include a display setting selector 328 operable to, when selected by the user via the primary user interface 30, cause the processor 58 to modify a display size of the chart 302.

In one embodiment, the backtesting session view 300 may further include a user settings menu 336 operable to display, on the primary user interface 30, an icon associated with a logged-in user account for the user 14 and a settings menu. The user's user account may include account information, such as a user's name, an email address, a username, custom settings, account properties, calendar settings, and/or the like.

In one embodiment, the economic calendar option 316e, when selected by the user, causes the processor 58 to display an economic calendar drawer 400 within the primary user interface 30 on the output device 54 of the user device 18. Upon selection of the economic calendar option 316e, the processor 58 may send a request to the backtesting system 22 for calendar settings and economic events data for the user 14 based on the current backtesting session. The request may include at least the username, one or more backtesting session property (such as a backtesting identifier), the simulation time 310, user authentication information, and/or the like. The processor 58 may then receive the calendar settings and economic events data sent by the backtesting system 22, e.g., via the network 26, and may, in some embodiments, store the calendar settings and economic events data in the memory 66. The economic events data may include one or more event property for at least one economic event, for example, the one or more event property may include one or more of: an event title, an event country, an event actual value, an event previous value, an event change value, an event change percentage, an event estimate, an event timestamp, and an event impact, or the like.

In some embodiments, the backtesting processor 86 may transmit a plurality of economic events, each economic event having the one or more event property, to the processor 58. For example, the backtesting processor 86 may transmit all data for an economic event to the processor 58. The processor 58 may only cause to be displayed, for example, a first set of the one or more event property comprising the event title, the event country, the event previous value, the event estimate, the event timestamp and the event impact at a first instance in time when the event timestamp is subsequent to the simulation time 310 (e.g., when the economic event is a “future event” described below) and may cause to be displayed, for example, a second set comprising the event actual value, the event change value, and the event change percentage at a second instance in time when the event timestamp is prior to, or includes, the simulation time 310. In this embodiment, then, the processor 58, and thus the user device 18, may have access to the second set of event properties prior to an instance in which the simulation time 310 reaches the event timestamp. In this way, the system 10 is able to accurately simulate the application of a particular trading strategy of the user on the historical securities data while not providing the user with information that would not have been available to a trader in real-world financial markets. Further, by providing the plurality of economic events to the user device 18 to include the event properties corresponding to a time both prior to, and subsequent to the simulation time, the system 10 provides a technical solution that reduces a number of transmissions to the user device while simultaneously minimizing computational resources used by the backtesting session 22 provide the event properties to the user device 18.

In some embodiments, the backtesting processor 86, for each economic event, may transmit a first set of the one or more event property at a first instance in time and a second set of the one or more event property at a second instance in time. For example, the backtesting processor 86 may transmit the first set comprising the event title, the event country, the event previous value, the event estimate, the event timestamp and the event impact at a first instance in time when the event timestamp is subsequent to the simulation time 310 (e.g., when the economic event is a “future event” described below) and may transmit the second set comprising the event actual value, the event change value, and the event change percentage at a second instance in time when the event timestamp is prior to, or includes, the simulation time 310. In this embodiment, then, the processor 58, and thus the user device 18, may not have access to the second set of event properties prior to an instance in which the simulation time 310 reaches the event timestamp. In some embodiments, the first set of event properties for each economic event having the event timestamp subsequent to the simulation time 310 may be transmitted to the user device 18 in one data transmission or data stream.

In one embodiment, the economic calendar drawer 400 may include one or more of an economic calendar 404 and an event filter control 408. The economic calendar drawer 400 may include one or more control 412 such as, for example, a filter control 412a and a close control 412b. In one embodiment, the filter control 412a may have a display state (e.g., an open state and a close state). The display state of the filter control 412a may be stored, e.g., by the processor 58 or backtesting processor 86 as a calendar setting and/or with the user account.

In one embodiment, upon selection of the filter control 412a by the user 14 via the one or more input device 50, the processor 58 may cause the event filter control 408 to be removed from the economic calendar drawer 400, e.g., from the primary user interface 30. In one embodiment, when the event filter control 408 is not shown, upon selection of the filter control 412a by the user 14 via the one or more input device 50, the processor 58 may cause the event filter control 408 to be displayed within the economic calendar drawer 400, e.g., above the economic calendar 404, in the primary user interface 30.

In one embodiment, upon selection of the close control 412b by the user 14 via the one or more input device 50, the processor 58 may cause the economic calendar drawer 400 to close such that the economic calendar drawer 400 may be removed from the primary user interface 30, and, in some embodiments, the chart 302 may expand to replace the economic calendar drawer 400.

In one embodiment, the event filter control 408 may include one or more filter option 416 (shown in FIG. 6A). Each filter option 416 may include at least one filter selection 420 indicative of a user selection or response to a particular one of the filter options 416. For example, as shown in FIG. 5, the event filter control 408 may include a first filter option 416a as a relative time option, a second filter option 416b as an impact option, and a third filter option 416c as a display option. While three filter options 416 are illustrated, it is understood that additional filter options 416 may be provided to the user 14 and that additional filter options 416 may be created for each property of the economic events data (e.g., event data for each economic event) and calendar settings.

In one embodiment, each filter option 416 may have a default value for each associated filter selection 420 stored in the memory 66 and retrievable by the processor 58. In one embodiment, when the user 14 interacts with the one or more filter selection 420, the processor 58 may send a signal to the backtesting system 22 indicative of such interaction, such as by sending a second request to the backtesting system 22 for calendar settings and economic events data for the user 14 based on the current backtesting session and the filter selections within the event filter control 408.

The first filter option 416a as the relative time option may include, for example, a first filter selection 420a indicative of a selection of the economic events to include in displayed economic events based on the event timestamp for a particular event in relation to the simulation time 310. For example, the first filter selection 420a is shown with as presenting the user 14, via the primary user interface 30, a selection between “past” events, “all” events, and “future” events. In this way, the user 14 may interact with the first filter selection 420a in the primary user interface 30 via the input device 50 to select one of “past” events, “future” events, and “all” events to be included as the displayed economic events. It should be understood that references to “past” and “future” are intended to refer to the economic event in relation to the simulation time 310 based on the event timestamp. For example, while an economic event may have an event timestamp that causes the economic event to be referred to as a “future” event, that economic event is a historic event in that the economic event is at least one market-day old, or from a prior market-day in real-world time (e.g., actual time, not the simulation time 310).

In one embodiment, past events may refer to one or more economic event having an event timestamp prior to (or including) the simulation time 310. The past events may include the one or more economic event having an event timestamp prior to the simulation time 310, but within the simulation timeframe. In some embodiments, the past events may include the one or more economic event having an event timestamp prior to the simulation time 310, and prior to the simulation timeframe within a predetermined past-event timeframe. For example, the predetermined past-event timeframe may be 7-days, such that the past events further include one or more economic event having an event timestamp within 7-days prior the simulation timeframe and economic events having an event timestamp prior to the simulation time 310 and within the simulation timeframe.

In one embodiment, future events may refer to one or more economic event having an event timestamp subsequent to the simulation time 310. The future events may include the one or more economic event having an event timestamp subsequent to the simulation time 310, but within the simulation timeframe. In some embodiments, the future events may include the one or more economic event having an event timestamp subsequent to the simulation time 310, and subsequent to the simulation timeframe within a predetermined future-event timeframe. For example, the predetermined future-event timeframe may be 7-days, such that the future events further include one or more economic event having an event timestamp within 7-days subsequent the simulation timeframe and economic events having an event timestamp subsequent to the simulation time 310 and within the simulation timeframe.

The second filter option 416b as the impact option may include, for example, a second filter selection 420b indicative of a selection of the economic events to include in displayed economic events based on the event impact of the event properties. The event impact property may include, for example only, a ranking of the economic event as being one or more of: low impact, medium impact, and high impact. The second filter selection 420b is shown as presenting the user 14, via the primary user interface 30, a selection between showing high impact economic events or showing economic events irrespective of the economic impact property. In this way, the user 14 may interact with the second filter selection 420b in the primary user interface 30 via the input device 50 to toggle the second filter selection 420b between showing only high impact events or to show events regardless of the event impact property. It should be understood that the event impact property may be any ranking system operable to compare the impact of economic events. For example, instead of high/medium/low, the event impacts may be ranked numerically, i.e., 1, 2, or 3. Further, additional rankings (e.g., for more impact granularity) may be included, for example, high/med-high/medium/med-low/low or, numerically, 1, 2, 3, 4, or 5. The impact granularity may be selected, e.g., by the user 14 and stored with the user settings, the calendar settings, or the filter properties, as described above.

The third filter option 416c as the display option may include, for example, a third filter selection 420c indicative of a selection of the displayed economic events to include in displayed event icons 450 (described below in more detail) based on the event timestamp and the simulation time 310. The third filter selection 420c is shown as presenting the user 14, via the primary user interface 30, a toggle to shown only future news on the chart 302. In this way, the user 14 may interact with the third filter selection 420c in the primary user interface 30 via the input device 50 to toggle the third filter selection 420c between including the displayed economic events within the displayed event icons or only including economic events having an event timestamp after the simulation time 310 as displayed event icons.

In one embodiment, the request may include the filter selections 420 such that the processor 58 may send the request to the backtesting system 22 where the request further includes indications of the filter selections 420 thereby causing the backtesting system 22 to send, to the processor 58 of the user device 18, economic event data for economic events included in one or more of: the displayed economic events and the displayed event icons. In this way, the amount of data transmitted from the backtesting system 22 and the user device 18 may be reduced, thereby improving stability of the system 10, decreasing computational requirements, and improving user experience.

In one embodiment, the economic calendar drawer 400 may include at least one country selection 424 indicative of one or more event country. In one embodiment, upon selection of one or more of the at least one country selection 424 by the user 14 via the one or more input device 50, the processor 58 may cause include a country selection in the request. The country selection may be indicative of one or more country from which the user 14 desires to view economic events. In one embodiment, the country selection 424 may be included with the event filter control 408. Selection of one or more of the at least one country selection 424 may cause the processor 58 to filter the displayed economic events based on the event country of the event properties such that only economic events within the displayed economic events having an event country among the selected countries of the at least one country selection 424 may be displayed in the economic calendar 404 and/or included in the displayed event icons on the chart 302. As shown, the country selection 424 may display a country icon 428, for example, based on a flag of the country. Further, as used herein, “country” may refer not only to a recognized country, but also to an unrecognized country, an economic union (e.g., the European Union), and/or the like.

In one embodiment, the event countries included in the country selection 424 may be based, at least in part, on what event countries are included in the displayed economic events after filtered by the event filter control 408. For example, if all economic events include event countries of a first country, a second country, and a third country, but, after filtering by the event filter control 408, only the first country and the second country are included in the displayed economic events, then the country selection 424 may include options relating to the first country and the second country.

In one embodiment, the event countries included in the country selection 424 may be based, at least in part, on a selection made by the user about what event countries to include. For example, the user 14 may select one or more event countries to include and such selection may be stored in the user settings. The event countries included by the user 14 may be related to the economic events of the historic market instrument of the backtesting session or, in other embodiments, may not be related to the economic events of the historic market instrument. For example, if the historic market instrument of the backtesting session is the S&P 500 (e.g., a historic market instrument based in the United States), the user 14 may select event countries other than the United States to be included in the economic calendar 404. In one embodiment, the event countries stored in the user account may be used as default event countries in the country selection 424.

In one embodiment, the processor 58 may receive economic events data sent by the backtesting system 22 and may process the economic events data based on the filter selections of the one or more event filter control 408 (e.g., to generate the displayed economic events) to present one or more economic event item 440a-n on the primary user interface 30 (shown in FIG. 6B). Each economic event item 440 may correspond to a particular economic event from the economic event data received from the backtesting system 22, and may display one or more of the event properties in labels 444, such as an event timestamp label 444a, an event title label 444b, an event countries label 444c, an event actual value label 444d, an event previous value label 444e, and an event change value label 444f. As used herein, reference to a “label” refers to a text field displayed on the primary user interface 30, unless stated to the contrary.

In one embodiment, even though the user device 18 have the economic calendar data having event property data for each economic event item 440, only particular ones of the event properties are displayed in the economic event items 440, based on the economic event being a future event, e.g., based on the event timestamp property of the particular economic event being after and the simulation time 310. As shown in FIGS. 6A-6B, for example, the economic event item 440a has an event timestamp label 444a-1, an event title label 444b-1, an event countries label 444c-1, an event actual value label 444d-1, an event previous value label 444e-1, and an event change value label 444f-1. The economic event item 440a has an economic timestamp of “Mar. 1, 2021 at 10:00 am” as illustrated by the economic event item 440a being under a first day label 448a of “Mon Mar. 1 2021” and having the event timestamp label 444a-1 of “10:00 am.” Thus, because the economic timestamp for the economic event item 440a is before the simulation time 310 of “9:00”, the processor 58 may only show the event previous value in the event previous value label 444e-1 but not show the event actual value in the event actual value label 444d-1 (and, optionally, show a first value placeholder 446a) or the event change value in the event change value label 444f-1 (and, optionally, show a second value placeholder 446b).

Conversely, as shown in FIGS. 6A and 6C, for example, economic event item 440b has an event timestamp label 444a-2, an event title label 444b-2, an event countries label 444c-2, an event actual value label 444d-2, an event previous value label 444e-2, and an event change value label 444f-2. The economic event item 440b has an economic timestamp of “Feb. 25, 2021 at 8:30 am” as illustrated by the economic event item 440b being under a second day label 448b of “Thu Feb. 25 2021” and having the event timestamp label 444a-2 of “8:30 am.” Thus, because the economic timestamp for the economic event item 440b is after the simulation time 310 of “9:00”, the processor 58 may show the event previous value in the event previous value label 444e-2, the event actual value in the event actual value label 444d-2, and the event change value in the event change value label 444f-2.

Referring again to FIG. 5, in one embodiment, upon selection of the events option 316f, the processor 58 may draw one or more event icon 450 associated with one or more economic event of the economic calendar 404 on the chart 302 on or near the axis of abscissas 306a at a time associated with the event timestamp of the one or more economic events. In one embodiment, the user 14 may filter the economic events to a filtered subset of the economic events provided as one or more displayed event icons (as described above in more detail). The displayed event icons may be event icons 450 associated with the filtered subset of the economic events, which may be shown as economic event items 440. In one embodiment, upon selection of the events option 316f, the processor 58 may send a signal to the backtesting system 22 to cause the backtesting system 22 to send the one or more event icon 450 associated with one or more economic event of the economic calendar 404 to the processor 58. The processor 58 may store the one or more event icon 450 in the memory 66. The processor 58 may then cause the one or more event icon 450 to be drawn on the chart 302 at locations corresponding to the event timestamp on the axis of abscissas 306a. In some embodiments, the processor 58 may determine a location on the chart 302 at which the one or more event icon 450 may be drawn so as to not interfere with other data presented in the primary user interface 30.

In one embodiment, the event icon 450, associated with a particular economic event of the filtered subset, may be selected based on the one or more countries of the event countries property of the particular economic event. For example, the event icon 450 may be based, at least in part, on the event countries label 444c of the economic event item 440 of the associated economic event.

In one embodiment, the displayed event icons may include a predetermined number of event icons 450. In some embodiments, the predetermined number of event icons 450 may be centered around the simulation time 310 or may only include event icons 450 for future events (as described above). For example, as shown in FIG. 5, the predetermined number of event icons 450 may be three event icons 450 having economic timestamps centered around the simulation time 310 on the axis of abscissas 306a (shown as a first event icon 450a corresponding to economic event item 440c, a second event icon 450b corresponding to economic event item 440a, and a third event icon 450c corresponding to economic event item 440d).

In one embodiment, each of the event icons 450 may be interactable by the user 14. For example, in one embodiment, upon selection of a particular event icon 450 by the user 14 interacting with the primary user interface 30 via the user device 18, the processor 58 may, responsive to such interaction, cause an event popup 460 to be displayed on the primary user interface 30 of the user device 18. The event popup 460 includes economic events data corresponding to the economic event associated with the particular event icon 450 selected by the user 14. In one embodiment, the processor 58 may select a position within the chart 302 to draw the event popup 460 such that the event popup 460 is near the selected event icon 450, yet does not overlay the chart 302.

In one embodiment, the event popup 460 may include one or more popup label 470 (also referred to herein as an event popup label) corresponding to event properties of the corresponding economic event. For example, a first popup label 470a may correspond to the event title, a second popup label 470b may correspond to the event country/countries, a third popup label 470c may correspond to the event actual value, a fourth popup label 470d may correspond to the event previous value, a fifth popup label 470e may correspond to the event change value, a sixth popup label 470f may correspond to the event change percentage, a seventh popup label 470g may correspond to the event estimate, and an eighth popup label 470h may correspond to the event impact. In other embodiments, additional ones of the one or more popup labels 470 may be included in the event popup 460 to correspond with others of the event properties. In yet other embodiments, the event popup 460 may include fewer popup labels 470 to display fewer, or other, event properties of the corresponding economic event.

In one embodiment, as shown in FIGS. 5 and 6D, selection of the second event icon 450b may cause the processor 58 to provide the event popup 460 with the one or more popup label 470 corresponding to event properties of the corresponding economic event based on the relationship between the simulation time 310 and the event timestamp property. For example, the third popup label 470c, the fifth popup label 470e and the sixth popup label 470f are shown with value placeholders, e.g., “—”, indicating that the simulation time 310 has not met or surpassed the event timestamp property of the corresponding economic event. That is, within the simulation timeframe, the corresponding economic event has yet to occur.

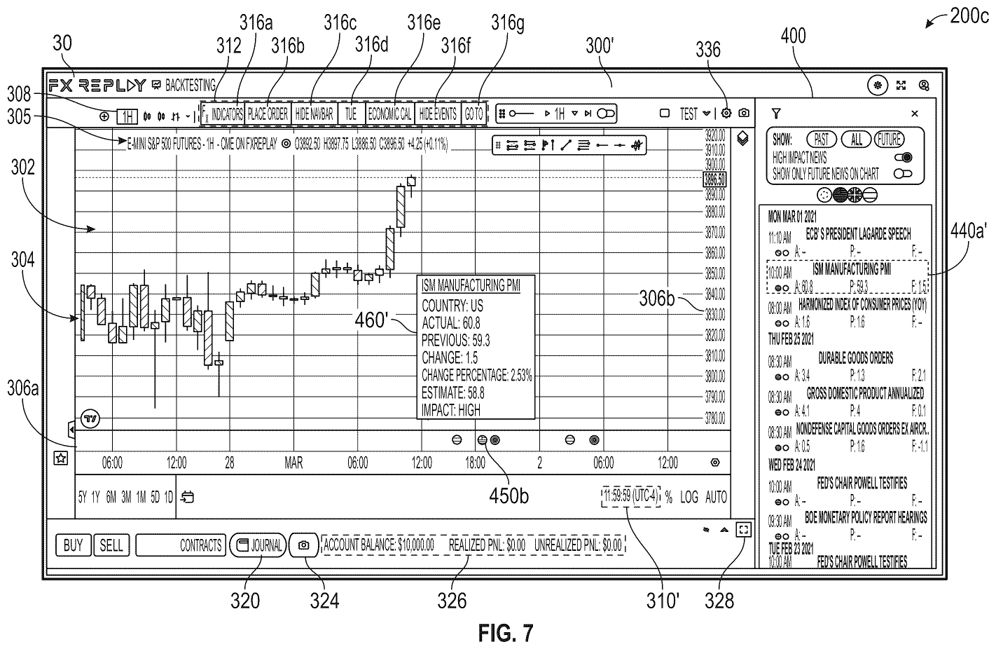

Referring now to FIG. 7, shown therein is a screenshot 200c of an exemplary embodiment of the user device 18 displaying the primary user interface 30 with a backtesting session view 300′ displayed in accordance with the present disclosure. Generally, the backtesting session view 300′ of FIG. 7 may be constructed in accordance with the backtesting session view 300 of FIG. 5 with the exception that the backtesting session view 300′ shows the backtesting session view 300 advanced from the simulation time 310 to a simulation time 310′. As shown in FIG. 7, the economic calendar drawer 400 includes economic event items 440, however, because the simulation time 310′ has advanced from the simulation time 310, the economic event item 440a is shown as an economic event item 440a′ having the first value placeholder 446a replaced with the event actual value property of “60.8” and the second value placeholder 446b replaced with the event change value “1.5”.

In one embodiment, because the simulation time 310′ has met or surpassed the event timestamp property of the corresponding event (e.g., of the economic event item 440a′) based on the relationship between the simulation time 310 and the event timestamp property, the event popup 460 has changed to an event popup 460′. For example, the third popup label 470c is shown with the event actual value, the fifth popup label 470e is shown with the event change value, and the sixth popup label 470f is shown with the event percent change value, and each of the third popup label 470c, the fifth popup label 470e and the sixth popup label 470f are now shown without value placeholders, e.g., “—”, because the simulation time 310′ is after the event timestamp of the corresponding economic event.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A system, comprising:
an output device;
an input device operable to receive one or more input from a user having a user account;
a processor in communication with the output device and the input device; and
a memory comprising a non-transitory processor-readable medium storing the user account and processor-executable instructions that when executed by the processor, causes the processor to:
generate a backtesting session view on the output device for a backtesting session comprising a historic market instrument mapped on a graph, the graph having an axis of abscissas corresponding to a time and an axis of ordinates corresponding to a value of the historic market instrument, the backtesting session view having a first simulation time;
retrieve economic events data comprising at least one economic event having a plurality of event properties, the plurality of event properties including at least an event timestamp and an event actual value, the event timestamp being subsequent to the first simulation time;
display an economic calendar comprising an economic event item associated with the at least one economic event in an economic calendar drawer of the backtesting session view, the economic event item having an actual value label having a value placeholder;
advance the first simulation time to a second simulation time at or after the event timestamp; and
cause the output device to show the event actual value for the actual value label of the economic event item and not show the value placeholder for the actual value label.

2. The system of claim 1, wherein the memory further comprises processor-executable instructions that cause the processor to:
receive a first input indicative of the user selecting an events option of the backtesting session view; and
in response to the first input, for each economic event of the at least one economic event, draw an event icon on the graph at a time corresponding to the event timestamp of the economic event.

3. The system of claim 2, wherein the memory further comprises processor-executable instructions that cause the processor to:
upon receiving a second input indicative of a user selecting a particular event icon, display an event popup having event popup labels displaying one or more event properties of the economic event corresponding to the particular event icon.

4. The system of claim 3, wherein the instructions to display the event popup further include instructions to display the value placeholder instead of the event actual value for a subset of the event properties for each event having the event timestamp subsequent to the first simulation time.

5. The system of claim 4, wherein prior to advancing the first simulation time to the second simulation time, the plurality of event properties further include one or more of: an event title, an event country, an event previous value, an event change value, an event change percentage, an event estimate, and an event impact, and wherein the subset of the event properties includes at least the event actual value, the event change value, and the event change percentage.

6. The system of claim 4, wherein the instructions further cause the processor to, subsequent to advancing the first simulation time to the second simulation time, replace the value placeholder with the event actual value for the subset of the event properties for each event having the event timestamp prior to the second simulation time.

7. The system of claim 1, wherein the economic calendar drawer further comprises an event filter control having one or more filter option, each filter option having at least one filter selection, and wherein the memory further comprises processor-executable instructions that cause the processor to:
receive a filter input indicative of the user modifying the at least one filter selection;
in response to the filter input, determine a filtered subset of the at least one economic event based on the at least one filter selection; and
update the economic calendar to display only economic event items associated with the filtered subset of the at least one economic event.

8. The system of claim 3, wherein the event properties further comprise an event previous value, and wherein when the event timestamp of the economic event corresponding to the particular event icon is after the second simulation time, the event popup displays the event actual value and the event previous value.

9. The system of claim 8, wherein when the event timestamp of the economic event corresponding to the particular event icon is before the second simulation time, the event popup displays the event previous value and does not display the event actual value.

10. The system of claim 1, wherein the memory further comprises processor-executable instructions that cause the processor to:
display at least one country selection indicative of one or more event country in the economic calendar drawer; and
upon receiving a country input indicative of the user selecting a particular country selection, filter the economic calendar to display only economic event items associated with economic events having an event country matching the particular country selection.

11. The system of claim 1, wherein the economic events data is retrieved from a non-relational database or a time-series database.

12. A method for backtesting financial strategies, comprising:
generating, by a processor, a backtesting session view on an output device for a backtesting session comprising a historic market instrument mapped on a graph, the graph having an axis of abscissas corresponding to a time and an axis of ordinates corresponding to a value of the historic market instrument, the backtesting session view having a first simulation time;
retrieving, by the processor, economic events data comprising a plurality of economic events, each economic event having a plurality of event properties including at least an event timestamp and an event actual value;
displaying, by the processor, an economic calendar comprising a plurality of economic event items associated with the plurality of economic events in an economic calendar drawer of the backtesting session view, wherein economic event items having an event timestamp subsequent to the first simulation time display a value placeholder instead of the event actual value;
advancing the first simulation time to a second simulation time;
updating, by the processor, the display of the economic calendar such that economic event items having an event timestamp between the first simulation time and the second simulation time display the event actual value instead of the value placeholder; and
updating, by the processor, the graph to display values of the historic market instrument up to the second simulation time.

13. The method of claim 12, further comprising:
receiving a filter input indicative of a user modifying at least one filter selection in an event filter control;
determining a filtered subset of the plurality of economic events based on the at least one filter selection; and
updating the economic calendar to display only economic event items associated with the filtered subset of the plurality of economic events.

14. The method of claim 12, further comprising:
receiving a first input indicative of a user selecting an events option of the backtesting session view; and
in response to the first input, for each economic event of the plurality of economic events, drawing an event icon on the graph at a time corresponding to the event timestamp of the economic event.

15. The method of claim 14, further comprising:
receiving a second input indicative of a user selecting a particular event icon; and
displaying an event popup having event popup labels displaying one or more event properties of the economic event corresponding to the particular event icon.

16. The method of claim 15, wherein when the event timestamp of the economic event corresponding to the particular event icon is prior to the second simulation time, the event popup displays the event actual value and an event previous value.

17. The method of claim 15, wherein when the event timestamp of the economic event corresponding to the particular event icon is after the second simulation time, the event popup displays an event previous value and does not display the event actual value.

18. The method of claim 12, wherein the economic events data is retrieved from a non-relational database or a time-series database.

19. The method of claim 12, further comprising:
displaying at least one country selection indicative of one or more event country in the economic calendar drawer; and
upon receiving a country input indicative of a user selecting a particular country selection, filtering the economic calendar to display only economic event items associated with economic events having an event country matching the particular country selection.

20. A computer-implemented method for backtesting financial strategies, the method performed by a processor, the method comprising:
causing a user device to generate a backtesting session view on an output device for a backtesting session comprising a historic market instrument mapped on a graph, the graph having an axis of abscissas corresponding to a time and an axis of ordinates corresponding to a value of the historic market instrument, the backtesting session view having a first simulation time;
transmitting, to the user device, economic events data comprising a plurality of economic events, each economic event having a plurality of event properties including at least an event timestamp and an event actual value;
causing the user device to display a value placeholder instead of the event actual value for each economic event having the event timestamp subsequent the first simulation time;
advancing the first simulation time to a second simulation time;
causing the user device to update the graph to display values of the historic market instrument up to the second simulation time; and
cause the user device to display an economic calendar such that economic event items having the event timestamp between the first simulation time and the second simulation time display the event actual value instead of the value placeholder.
